(19) United States
(12) Patent Application Publication
(10) Pub. No.: US 2025/0304103 A1
(43) Pub. Date: Oct. 2, 2025

(54) CONTROL DEVICE, CONTROL METHOD, AND STORAGE MEDIUM

(71) Applicant: HONDA MOTOR CO., LTD., Tokyo (JP)

(72) Inventors: Yoshihiro KATSUYAMA, Tokyo (JP); Hironori HIRATA, Tokyo (JP)

(73) Assignee: HONDA MOTOR CO., LTD., Tokyo (JP)

(21) Appl. No.: 19/064,717

(22) Filed: Feb. 27, 2025

(30) Foreign Application Priority Data
Mar. 27, 2024 (JP) 2024-050999

(51) Int. Cl. B60W 60/00; B60K 35/21; G06F 3/14; G06T 5/50; G06V 20/56

(52) U.S. Cl. CPC B60W 60/001; B60K 35/21; G06F 3/14; G06T 5/50; G06V 20/56; G06T 2207/20221

(57) ABSTRACT

A control device includes: an acquisition unit; an image processing unit configured to generate a first top view image in which a vehicle is viewed from sky and from a rear side with respect to a center of the vehicle in a traveling direction with a front side in the traveling direction included in an angle of view, and a second top view image in which the vehicle is viewed from the sky in a vertical direction; a control unit configured to control movement of the vehicle to a target position; and a display control unit. The display control unit is configured to cause a display unit to display the first top view image in response to a distance to the target position being equal to or greater than a predetermined value, and the second top view image in response to the distance being less than the predetermined value.

This application is based upon and claims the benefit of priority from prior Japanese patent application No. 2024-50999, filed on Mar. 27, 2024, the entire contents of which are incorporated herein by reference.

### TECHNICAL FIELD

The present invention relates to a control device, a control method, and a storage medium storing a control program.

### BACKGROUND ART

In recent years, active efforts have been made to provide access to a sustainable transportation system in consideration of vulnerable traffic participants. As one of these efforts, research and development on driving assistance techniques and autonomous driving techniques for vehicles such as automobiles have been made in order to further improve safety and convenience of traffic.

For example, a system that performs driving assistance by displaying a camera image on a display is well-known in the related art. As an example of such a system, US2016/0021312 A1 discloses a technique that performs driving assistance by displaying a peripheral image including a vehicle on a display by using a function of around view monitoring, for example, when the vehicle is moving at a low speed (or when parking).

### SUMMARY OF INVENTION

However, simply displaying a peripheral image of a vehicle, as in the related art, may be insufficient for a traveling situation. For example, when the vehicle is not traveling at a low speed but is traveling normally, a user such as a driver may want to check a situation of the vehicle in a traveling direction (for example, a situation in the distance not included in the peripheral image) from the peripheral image of the vehicle, and a display corresponding to the traveling situation of the vehicle is desired.

Aspects of the present disclosure relate to providing a control device, a control method, and a storage medium storing a control program that enable a display that corresponds to a traveling situation of a vehicle.

According to an aspect of the present disclosure, there is provided a control device that causes a vehicle to move to a predetermined target position, the control device including:
an acquisition unit configured to acquire external information indicating a situation of a periphery of the vehicle from an external sensor including an imaging device for imaging the periphery of the vehicle;
an image processing unit configured to generate, based on the acquired external information, a first top view image in which the vehicle is viewed from sky and from a rear side with respect to a center of the vehicle in a traveling direction of the vehicle with a front side in the traveling direction included in an angle of view, and a second top view image in which the vehicle is viewed from the sky in a vertical direction of the vehicle;
a control unit configured to control movement of the vehicle to the target position; and
a display control unit configured to cause a predetermined display unit to display images generated by the image processing unit, in which
the display control unit is configured to
   cause the display unit to display the first top view image in response to a distance to the target position being equal to or greater than a predetermined value, and
cause the display unit to display the second top view image in response to the distance to the target position being less than the predetermined value.

According to another aspect of the present disclosure, there is provided a control method, including:
acquiring, by a computer that causes a vehicle to move to a predetermined target position, external information indicating a situation of a periphery of the vehicle from an external sensor including an imaging device for imaging the periphery of the vehicle,
generating, by the computer, based on the acquired external information, a first top view image in which the vehicle is viewed from sky and from a rear side with respect to a center of the vehicle in a traveling direction of the vehicle with a front side in the traveling direction included in an angle of view, and a second top view image in which the vehicle is viewed from the sky in a vertical direction of the vehicle,
controlling, by the computer, movement of the vehicle to the target position,
causing, by the computer, a predetermined display unit to display the generated images,
causing, by the computer, the display unit to display the first top view image in response to a distance to the target position being equal to or greater than a predetermined value, and
causing, by the computer, the display unit to display the second top view image in response to the distance to the target position being less than the predetermined value.

According to another aspect of the present disclosure, there is provided a non- transitory computer-readable storage medium storing a control program causing a computer that causes a vehicle to move to a predetermined target position to execute a process, the process including:
acquiring external information indicating a situation of a periphery of the vehicle from an external sensor including an imaging device for imaging the periphery of the vehicle,
generating, based on the acquired external information, a first top view image in which the vehicle is viewed from sky and from a rear side with respect to a center of the vehicle in a traveling direction of the vehicle with a front side in the traveling direction included in an angle of view, and a second top view image in which the vehicle is viewed from the sky in a vertical direction of the vehicle,
controlling movement of the vehicle to the target position,
causing a predetermined display unit to display the generated images,
causing the display unit to display the first top view image in response to a distance to the target position being equal to or greater than a predetermined value, and causing the display unit to display the second top view image in response to the distance to the target position being less than the predetermined value.

According to another aspect of the present disclosure, there is provided a control device that causes a vehicle to move to a predetermined target position, the control device including:
an acquisition unit configured to acquire external information indicating a peripheral situation of the vehicle from an external sensor including an imaging device for imaging the periphery of the vehicle;
an image processing unit configured to generate, based on the acquired external information, a top view image in which the vehicle is viewed from the sky and from a rear side with respect to a center of the vehicle in a traveling direction of the vehicle with a front side in the traveling direction included in an angle of view;
a control unit configured to control movement of the vehicle to the target position; and
a display control unit configured to cause a predetermined display unit to display the top view image generated by the image processing unit, in which
the display control unit causes the display unit to display the top view image when the vehicle moves in reverse to a predetermined place.

According to aspects of the present disclosure, it may be possible to perform a display corresponding to a traveling situation of a vehicle. This further improves safety of traffic and contributes to development of a sustainable transportation system.

### BRIEF DESCRIPTION OF DRAWINGS

Exemplary embodiment(s) of the present invention will be described in detail based on the following figures, wherein:

FIG. 1 is a block diagram showing a schematic configuration of a vehicle 1 equipped with a control device 30 according to an embodiment;

FIG. 2 is a diagram showing an example of a route for moving to a parking position 211 through a driveway 201;

FIG. 3 is a diagram showing an example of a first top view image;

FIG. 4 is a diagram showing an example of a second top view image;

FIG. 5 is a diagram showing an example of a superimposed image;

FIG. 6 is a flowchart (part 1) showing an example of processing executed by the control device 30 of the embodiment;

FIG. 7 is a flowchart (part 2) showing an example of the processing executed by the control device 30 of the embodiment;

FIG. 8 is a flowchart (part 3) showing an example of the processing executed by the control device 30 of the embodiment; and

FIG. 9 is a diagram for illustrating an example of another embodiment.

### DESCRIPTION OF EMBODIMENTS

Hereinafter, an embodiment of a vehicle control device according to the present disclosure will be described with reference to the drawings. The following embodiment does not limit the present disclosure, and not all of elements described in the following embodiment are necessary to the present disclosure. In addition, two or more elements described in the following embodiment may be freely combined without departing the gist of the present disclosure. Hereinafter, the same or similar elements are denoted by the same or similar reference signs, and a description thereof may be omitted or simplified.

### Vehicle Equipped With Control Device

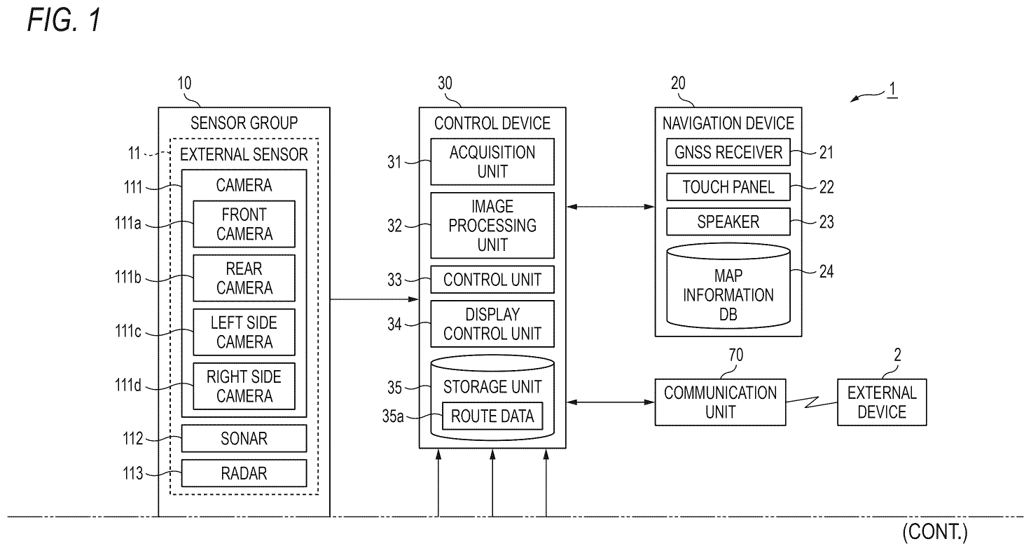

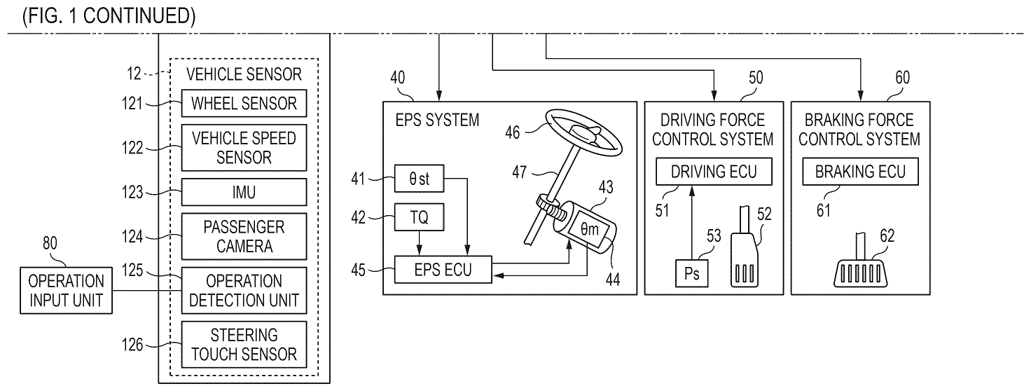

First, a vehicle of the present embodiment will be described. FIG. 1 is a block diagram showing a configuration of a vehicle 1 equipped with a control device 30 of the embodiment. The vehicle 1 is an automobile including a drive source (not shown) and wheels including drive wheels driven by power of the drive source and steerable steered wheels. As an example, the vehicle 1 can be a four-wheeled automobile having a pair of left and right front wheels and a pair of left and right rear wheels.

The drive source of the vehicle 1 may be an electric motor, may be an internal combustion engine such as a gasoline engine or a diesel engine, or may be a combination of an electric motor and an internal combustion engine. The drive source of the vehicle 1 may drive the pair of left and right front wheels, may drive the pair of left and right rear wheels, or may drive four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

The vehicle 1 is capable of driving assistance and autonomous driving autonomously controlling a driving operation to travel. The autonomous driving defined here means that a system of a vehicle performs all driving operations such as recognition or monitoring of a travel environment and peripheral situations, as well as starting, accelerating/decelerating, steering, and stopping. The driving assistance means that a system of a vehicle performs some of driving operations such as starting, accelerating/decelerating, steering, and stopping, and is, for example, an automatic parking system (APS), a lane keep assist system (LKAS), and adaptive cruise control (ACC). In the embodiment described below, an example in which the vehicle 1 is moved to a parking position designated by a user as a target position until the vehicle 1 reaches the parking position will be described. As is well-known in the related art, a plurality of levels of a driving control in the autonomous driving and the driving assistance may be present, and may be defined, for example, as levels 0 to 5 established by the Society of Automotive Engineers (SAE) of the United States. Regarding the level of the driving control, the larger the level number, the lighter an operational burden of a driver (in other words, the larger the level number, the higher the degree of automation). Specific contents of level 0 to level 5 are well-known, and thus descriptions thereof are omitted here.

The vehicle 1 includes a sensor group 10, a navigation device 20, the control device 30, an electric power steering (EPS) system 40, a driving force control system 50, a braking force control system 60, a communication unit 70, and an operation input unit 80.

The sensor group 10 includes an external sensor 11 that acquires information about the periphery of the vehicle 1, and a vehicle sensor 12 that acquires information about the vehicle 1. Information (in other words, detection values) acquired by each sensor included in the sensor group 10 is output to the control device 30.

The external sensor 11 includes, for example, a camera 111, a sonar 112, and a radar 113. The camera 111 is a digital camera that images the periphery, including the vehicle 1, of the vehicle 1, and outputs image data of the obtained peripheral image to the control device 30. In the present embodiment, the vehicle 1 has a front camera 111a, a rear camera 111b, a left side camera 111c, and a right side camera 111d in order to acquire peripheral images in all directions of the vehicle 1.

The front camera 111a is provided, for example, at an upper portion of a front window in a passenger compartment or a front bumper, and images a front region of the vehicle 1. The rear camera 111b is provided, for example, at a rear bumper or the like, and images a rear region of the vehicle 1. The left side camera 111c is provided, for example, at a left side mirror, and images a left side region of the vehicle 1. The right side camera 111d is provided, for example, at a right side mirror, and images a right side region of the vehicle 1. Each of the cameras 111a to 111d may be a digital camera using an imaging element such as a charge coupled device (CCD) or a complementary metal oxide semiconductor (CMOS). The front camera 111a, the rear camera 111b, the left side camera 111c, and the right side camera 111d are examples of an imaging device in the present disclosure. In the following description, the front camera 111a, the rear camera 111b, the left side camera 111c, and the right side camera 111d will be simply referred to as a “camera 111” unless these cameras are particularly distinguished from one another.

The sonar 112 emits sound waves to the periphery of the vehicle 1 (for example, front, rear, and sides of the vehicle 1), and receives reflected sound from an object present in the periphery of the vehicle 1 to detect a distance to, an orientation of, or the like of the object. The detected information is transmitted to the control device 30 at a predetermined cycle. The radar 113 emits radio waves to the periphery of the vehicle 1 which includes the front of the vehicle 1, and receives the reflected waves from an object present in the periphery of the vehicle 1 to detect a distance to, an orientation of, or the like of the object. The detected information is transmitted to the control device 30 at a predetermined cycle. For example, a millimeter wave radar can be used as the radar 113.

The external sensor 11 may include a light detection and ranging (LiDAR) instead of or in addition to the sonar 112 and the radar 113. In this case, the LiDAR emits a laser light to the periphery of the vehicle 1 which includes the front of the vehicle 1, and receives the reflected light from an object present in the periphery of the vehicle 1 to detect a distance to, an orientation of, or the like of the object.

The vehicle sensor 12 includes, for example, a wheel sensor 121, a vehicle speed sensor 122, an inertial measurement unit (IMU) 123, a passenger camera 124, an operation detection unit 125, and a steering touch sensor 126.

The wheel sensor 121 detects a rotation angle of one or more wheels of the wheels included in the vehicle 1. As an example, the wheel sensor 121 detects a rotation angle of each of the left rear wheel and the right rear wheel. For example, an angle sensor or a displacement sensor can be used as the wheel sensor 121.

The vehicle speed sensor 122 detects a vehicle speed, which is a travel speed of the vehicle 1 (in other words, a movement speed of a vehicle body). For example, the vehicle speed sensor 122 detects the vehicle speed based on the number of revolutions of a countershaft (not shown) included in the vehicle 1.

The inertial measurement unit 123 detects angular velocities in a pitch direction, a roll direction, and a yaw direction of the vehicle 1, and accelerations in a front-rear direction, a left-right direction, and an upper-lower direction of the vehicle 1. The vehicle sensor 12 may include, instead of the inertial measurement unit 123, an acceleration sensor that detects an acceleration in a predetermined direction of the vehicle 1 and a gyro sensor that detects an angular velocity in a predetermined direction of the vehicle 1.

The passenger camera 124 is a digital camera that images an interior of the vehicle 1 and outputs image data of the obtained interior image to the control device 30. For example, the passenger camera 124 can be a “driver monitor camera” that is provided to be capable of imaging the head of the driver sitting in a driver seat of the vehicle 1 from the front (in other words, to image the face). A digital camera using an imaging element such as a CCD or CMOS can be used as the passenger camera 124, similar to the camera 111. In the present embodiment, the image data of the interior image obtained by the passenger camera 124 imaging the interior of the vehicle is information that can identify an orientation of a line of sight of the driver.

The operation detection unit 125 detects an operation performed using the operation input unit 80 that is provided to be capable of being operated by passengers including the driver. In the present embodiment, the operation input unit 80 includes, for example, an operation switch (not shown) that accepts an operation to switch the autonomous driving or automatic parking on (in other words, to be activated) and off (in other words, to be deactivated). In this case, the operation detection unit 125 can detect the operation to turn the autonomous driving or automatic parking on or off.

The steering touch sensor 126 detects whether a steering wheel 46 of the vehicle 1 is being held properly. For example, the steering touch sensor 126 is implemented by a capacitance sensor or the like. In this case, the capacitance sensor is provided at a portion where the driver touches the steering wheel 46 when the steering wheel 46 is being held properly.

The navigation device 20 includes, for example, a global navigation satellite system (GNSS) receiver 21, a touch panel 22, and a speaker 23. The navigation device 20 also has a storage unit (not shown) that is implemented by a flash memory or the like. The storage unit of the navigation device 20 stores a map information database (DB) 24 and the like.

The GNSS receiver 21 identifies a current position of the vehicle 1 (for example, a latitude and a longitude of a position where the vehicle 1 is located) based on a signal received from a GNSS satellite. The navigation device 20 may acquire, for example, a detection result of the vehicle sensor 12 (for example, the wheel sensor 121 or the vehicle speed sensor 122) via the control device 30, and identify or complement the current position of the vehicle 1 by an inertial navigation system (INS) using the detection value of the vehicle sensor 12.

The touch panel 22 functions as an input device that receives input of various types of information to the control device 30 and as a display device controlled by the control device 30. The touch panel 22 is implemented by combining a display device such as a liquid crystal display or an organic light emitting diode (OLED) with a pointing device (for example, touch pad). The speaker 23 is configured to output sound to a passenger (for example, driver) of the vehicle 1. The touch panel 22 is an example of a “predetermined display unit” in the present invention.

For example, by referring to the map information database 24, the navigation device 20 searches for a route from the current position of the vehicle 1 to a destination set by the driver using the touch panel 22. Then, the navigation device 20 performs route guidance using the touch panel 22 and the speaker 23 based on the searched route. The navigation device 20 may also cause the touch panel 22 to perform a predetermined display according to an instruction from the control device 30. A specific display will be described later. Furthermore, the navigation device 20 may output, to the control device 30, predetermined information such as information indicating the identified current position of the vehicle 1 or information indicating an operation accepted via the touch panel 22.

The control device 30 is, for example, a computer that includes a processor for performing various calculations, a storage unit 35 having a non-transitory storage medium for storing various kinds of information, an input and output unit for controlling input and output of data between the inside and outside of the control device 30, and the like (not shown), and controls the entire vehicle 1.

The storage unit 35 stores various kinds of data and programs to be executed by the control device 30. For example, the storage unit 35 stores route data 35a when the vehicle 1 moves to a predetermined target position. The route data 35a is information indicating a route history when the vehicle 1 moves to the target position, and the route data is accumulated as the vehicle 1 moves. In addition to route information, the route data includes information on vegetation and obstacles present on the route. In particular, in the present embodiment, when the vehicle 1 moves through a place (for example, private land) not included in the map information database 24, the control device 30 refers to the route data 35a and executes image display processing described below. The predetermined target position is assumed to be, for example, a parking position designated by the user. In the following description, the parking position designated by the user is described as the target position.

The control device 30 is implemented by one electronic control unit (ECU) or by a plurality of ECUs working together. The control device 30 performs the driving assistance such as controlling the vehicle on behalf of the driver, and can therefore be called a control device in an advanced driving assistance system (ADAS ECU). A specific configuration and a specific example of control of the control device 30 will be described later, and thus descriptions thereof are omitted here.

The EPS system 40 includes, for example, a steering angle sensor 41, a torque sensor 42, an EPS motor 43, a resolver 44, and an EPS ECU 45.

The steering angle sensor 41 detects a steering angle θst of the steering wheel 46, and outputs information indicating the detected steering angle θst to the EPS ECU 45. The torque sensor 42 detects steering torque TQ, which is torque applied to the steering wheel 46 of the vehicle 1, and outputs information indicating the detected steering torque TQ to the EPS ECU 45.

The EPS motor 43 assists the driver in operating the steering wheel 46 by applying, according to an instruction from the EPS ECU 45, a driving force or a reaction force to a steering column 47 connected to the steering wheel 46. The resolver 44 detects a rotation angle θm of the EPS motor 43, and outputs information indicating the detected rotation angle θm to the EPS ECU 45.

The EPS ECU 45 is, for example, a computer that includes a processor for performing various calculations, a storage unit including a non-transitory storage medium for storing various kinds of information, an input and output unit for controlling input and output of data between the inside and outside of the EPS ECU 45, and the like (all not shown), and controls the EPS system 40 (for example, EPS motor 43), and is implemented by one or more ECUs. For example, the EPS ECU 45 controls the EPS system 40 (for example, EPS motor 43) based on the steering angle θst detected by the steering angle sensor 41, the steering torque TQ detected by the torque sensor 42, the rotation angle θm detected by the resolver 44, and the like.

The EPS system 40 (for example, EPS ECU 45) may output, to the control device 30, the information indicating the steering angle θst detected by the steering angle sensor 41, the steering torque TQ detected by the torque sensor 42, the rotation angle θm detected by the resolver 44, and the like. Furthermore, the EPS system 40 (for example, EPS ECU 45) may output information indicating a steering speed o of the steering wheel 46 to the control device 30. In this case, the steering speed ω is obtained, for example, by time-differentiating the steering angle θst.

The driving force control system 50 includes a driving ECU 51, and can control a driving force of the vehicle 1. The driving ECU 51 is, for example, a computer that includes a processor for performing various calculations, a storage unit including a non-transitory storage medium for storing various kinds of information, an input and output unit for controlling input and output of data between the inside and outside of the driving ECU 51, and the like (all not shown), and controls the driving force control system 50, and is implemented by one or more ECUs. For example, the driving ECU 51 controls the driving force output from the drive source of the vehicle 1 based on an amount of operation of an accelerator pedal 52 provided at the vehicle 1 and a detection value of a shift position sensor 53 that detects a shift position Ps of a shift device (for example, a shift lever or a shift switch) (not shown). The drive source is an internal combustion engine or a motor as described above, and the driving ECU 51 controls output of the internal combustion engine or the motor based on the amount of operation of the accelerator pedal 52 and the shift position Ps. The driving ECU 51 can also control the driving force control system 50 (for example, the drive source) according to an instruction from the control device 30.

The braking force control system 60 includes a braking ECU 61 and can control a braking force of the vehicle 1. The braking ECU 61 is, for example, a computer that includes a processor for performing various calculations, a storage unit including a non-transitory storage medium for storing various kinds of information, an input and output unit for controlling input and output of data between the inside and outside of the braking ECU 61, and the like (all not shown), and controls the braking force control system 60, and is implemented by one or more ECUs. For example, the braking ECU 61 controls the braking force of the vehicle 1 by controlling a brake device (not shown) included in the vehicle 1 based on an operation on a brake pedal 62 provided on the vehicle 1. Here, the brake device includes, for example, a brake caliper, a cylinder that transmits a hydraulic pressure to the brake caliper, and an electric motor that generates the hydraulic pressure in the cylinder. The braking ECU 61 controls the electric motor of the brake device such that a braking force corresponding to the operation on the brake pedal 62 is generated. The braking ECU 61 can also control the braking force control system 60 according to an instruction from the control device 30.

The communication unit 70 is a communication interface that communicates with an external device 2 under an instruction of a control performed by the control device 30. That is, the control device 30 may communicate with the external device 2 via the communication unit 70. Examples of the external device 2 may include a terminal device (for example, a smartphone) of the driver and a server device managed by a manufacturer of the vehicle 1. For example, a mobile communication network such as a cellular line, Wi-Fi (registered trademark), bluetooth (registered trademark), or the like can be used for the communication between the vehicle 1 and the external device 2.

### Control Device

Next, the control device 30 will be specifically described. The control device 30 executes, for example, various programs stored in the storage unit 35 of the control device 30. In the present embodiment, the control device 30 causes the vehicle 1 to autonomously move to a parking position which is the predetermined target position designated by a user including the driver of the vehicle 1, other passengers, and the like (hereinafter, also referred to as the “user”), and executes a control to display an image corresponding to a traveling situation of the vehicle 1 on a display unit such as the touch panel 22 during the movement.

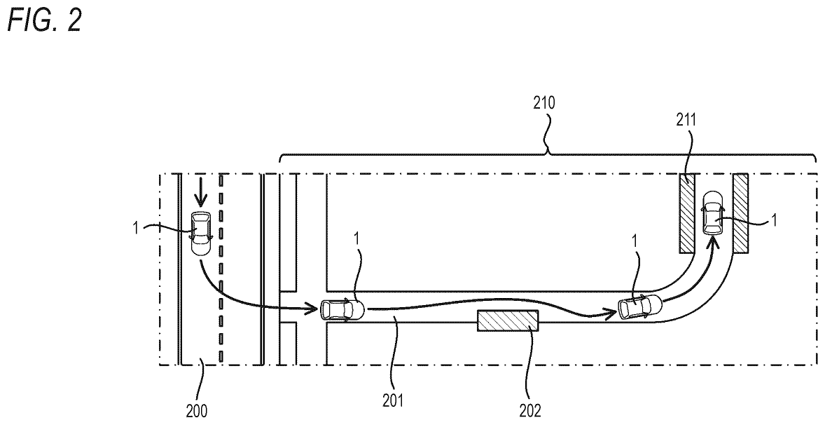

Here, in the present embodiment, an example of a route for movement of the vehicle 1 to the parking position will be described. FIG. 2 is a diagram showing the example of the route. As shown by arrows in FIG. 2, the vehicle 1 may enter a private land 210 of the user while traveling on a general road 200 which is a public road (including a highway or the like), and move to a parking position 211 in a garage or the like provided in the private land 210 as the target position. A section from a position where the vehicle 1 enters the private land 210 to the parking position 211 is a driveway 201 indicating a road in the private land 210. An obstacle 202 on the driveway 201 is, for example, a permanent trash can or vegetation. The control device 30 causes the vehicle 1 to move along the driveway 201 toward the parking position 211 based on external information acquired by the camera 111 or the like and the route data 35a.

In the autonomous driving, as is well-known in the related art, the vehicle 1 travels while recognizing a peripheral situation thereof by using the camera 111 or the like mounted on the vehicle 1. In this case, the vehicle 1 may travel while displaying a peripheral image showing the peripheral situation of the vehicle 1 on the display unit such as the touch panel 22. On the other hand, some users may want to know a situation in a traveling direction (for example, a situation in the distance not included in the peripheral image) rather than the peripheral situation of the vehicle 1 during the traveling. In such a case, it is preferable that an image corresponding to the traveling situation of the vehicle 1 is displayed on the display unit such as the touch panel 22. Therefore, in the present embodiment, the display unit such as the touch panel 22 is configured to display the image corresponding to the traveling situation.

Specifically, the control device 30 executes, as an example of a program recorded in the storage unit 35, a program for image display processing of displaying an image during the autonomous driving when a start of the autonomous driving is detected through the operation of the operation switch in the operation input unit 80 and the operation on the touch panel 22 or the like. The control device 30 includes an acquisition unit 31, an image processing unit 32, a control unit 33, and a display control unit 34 as functional units that are implemented by the execution of the program. In the following, the processing described as one performed by the acquisition unit 31, the image processing unit 32, the control unit 33, and the display control unit 34 is implemented by the control device 30.

The acquisition unit 31 acquires external information indicating the peripheral situation of the vehicle 1. For example, the acquisition unit 31 performs sensor fusion processing on detection values from some or all of the camera 111, the sonar 112, and the radar 113 included in the external sensor 11, recognizes the peripheral situation of the vehicle 1 based on the processing result, and acquires the external information indicating the recognition result. More specifically, the acquisition unit 31 recognizes a position, a type, a speed, an acceleration, and the like of an object present in the periphery of the vehicle 1. In this case, the acquisition unit 31 recognizes the position of the object as a position on absolute coordinates with a representative point of the vehicle 1 (for example, the center of gravity or a center of a drive shaft) as an origin, for example. Accordingly, a relative position between the vehicle 1 and the object present in the periphery thereof can be recognized. In addition, on the absolute coordinates, the position of the object may be represented by the representative point such as the center of gravity or a corner of the object, or may be represented as a region. The acquisition unit 31 acquires the external information not only during the traveling on the driveway 201 described above, but also during the traveling on the general road 200 (that is, acquires at all times during the traveling).

The acquisition unit 31 can recognize, for example, the obstacle 202 present in the periphery of the vehicle 1 as the object present in the periphery of the vehicle 1. Examples of the obstacle 202 include a trash can permanently installed on the road, objects that fall onto the road, and other traffic participants (for example, other vehicles and pedestrians).

The acquisition unit 31 also recognizes, for example, a position and an attitude of the vehicle 1 during the traveling. For example, the acquisition unit 31 recognizes the position of the vehicle 1 by acquiring a road division line in the periphery of the vehicle 1 and a division line indicating a parking frame in a parking position from an image captured by the camera 111. The acquisition unit 31 also recognizes the position and the attitude of the vehicle 1 based on, for example, a deviation from the road division line or the division line in the parking frame, and an angle between the vehicle and the road division line or the division line in the parking frame. The acquisition unit 31 may recognize the position and the attitude of the vehicle 1 by recognizing not only the road division line or the division line in the parking frame, but also a boundary with the road, including a road shoulder, a curb, a block wall, a guard rail, or the like, and a boundary with the parking position.

The image processing unit 32 performs image processing based on the external information acquired by the control device 30 through the function of the acquisition unit 31. Specifically, based on the imaging data acquired by the front camera 111a, the rear camera 111b, the left side camera 111c, and the right side camera 111d, the image processing unit 32 generates a composite image obtained by combining the images captured by these cameras 111a to 111d (hereinafter, also simply referred to as a “composite image”). Based on the generated composite image, the image processing unit 32 generates a first top view image in which the vehicle 1 is viewed from the sky behind the center of the vehicle with the traveling direction of the vehicle 1 included in an angle of view, and a second top view image in which the vehicle 1 is viewed from the sky in a vertical direction of the vehicle 1.

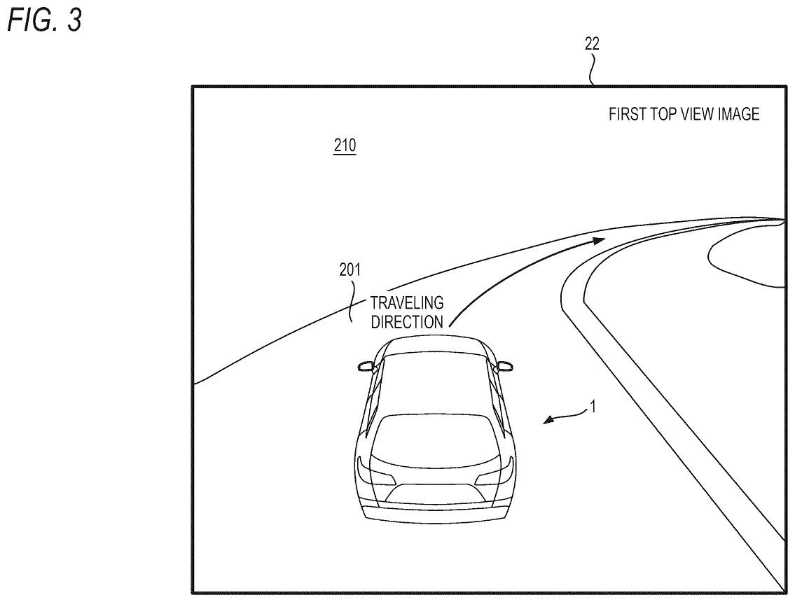

Here, the “first top view image in which the vehicle 1 is viewed from the sky behind the center of the vehicle with the traveling direction included in an angle of view” refers to, for example, an image in which in a case of the vehicle 1 moving forward, the forward direction is the traveling direction, and the vehicle 1 is viewed from at least the sky behind the center of the vehicle (in other words, the diagonally sky behind the vehicle 1) with the traveling direction included in the angle of view. FIG. 3 is a diagram showing an example of the first top view image in which the vehicle 1 is viewed from the rear upper sky. As shown in FIG. 3, by displaying the first top view image in which the vehicle 1 is viewed from the sky behind the vehicle 1 on the touch panel 22, the user can know not only the peripheral situation of the vehicle 1 but also the situation in the traveling direction.

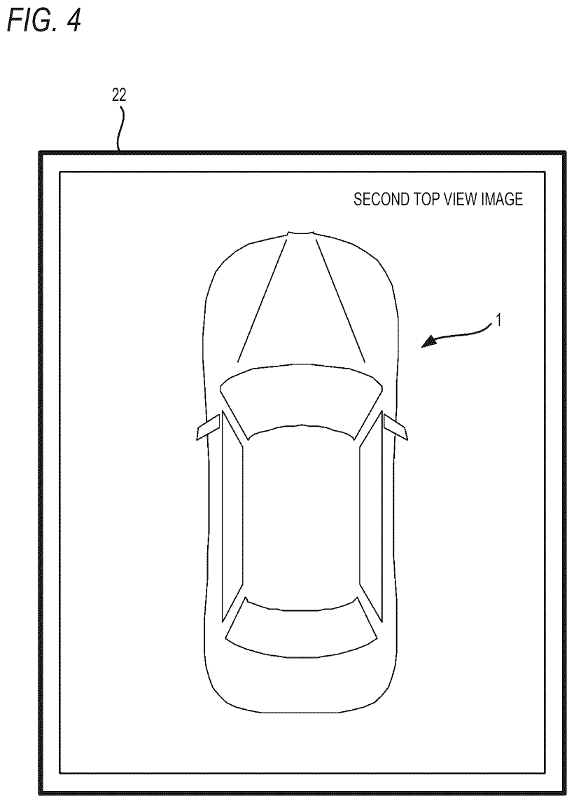

The “second top view image in which the vehicle is viewed from the sky in the vertical direction of the vehicle” refers to, for example, an image in which the vehicle 1 is viewed from the sky (for example, directly above the vehicle) with the vehicle 1 at the center. FIG. 4 is a diagram showing an example of the second top view image in which the vehicle is viewed from the sky in the vertical direction. As shown in FIG. 4, by displaying, on the touch panel 22, the second top view image in which the vehicle 1 is viewed from the sky in the vertical direction, the user can know the peripheral situation of the vehicle 1.

The first top view image includes, for example, a captured image (camera image) based on the imaging data of the camera 111, and a virtual image which is a virtual three- dimensional image generated based on the imaging data of the camera 111. The captured image in the first top view image is, for example, an image showing a mode in which the above composite image is subjected to image processing for reconstructing the composite image three- dimensionally, and the vehicle 1 and the periphery of the vehicle 1 are rotated to view the vehicle 1 from the sky behind the center of the vehicle with the traveling direction included in the angle of view.

The virtual image in the first top view image is, for example, an image showing, by computer graphics (CG), a mode in which the vehicle 1 is viewed from the sky behind the center of the vehicle with the traveling direction included in the angle of view. For example, in the virtual image in the first top view image, the object (for example, obstacle 202) present in the periphery of the vehicle 1 is expressed by a polygon or the like.

Similarly, the second top view image includes, for example, a captured image (camera image) based on the imaging data of the camera 111, and a virtual image which is a virtual three-dimensional image generated based on the imaging data of the camera 111. The captured image in the second top view image is, for example, an image showing a mode in which the above composite image is subjected to image processing for reconstructing the composite image three-dimensionally, and the vehicle 1 and the periphery of the vehicle 1 are rotated to view the vehicle 1 from the sky in the vertical direction with the traveling direction included in the angle of view.

The virtual image in the second top view image is, for example, an image showing, by computer graphics (CG), a mode in which the vehicle 1 is viewed from the sky in the vertical direction. For example, in the virtual image in the second top view image, the object (for example, obstacle 202) present in the periphery of the vehicle 1 is expressed by a polygon or the like.

In the following description, for convenience of description, the captured image in the first top view image is also referred to as a “first captured image”, a three-dimensional image in the first top view image is also referred to as a “first virtual image”, the captured image in the second top view image is also referred to as a “second captured image”, and a three- dimensional image in the second top view image is also referred to as a “second virtual image”. In addition, when there is no distinction between the “first” and the “second”, these images are also simply referred to as a “top view image”, a “captured image”, and a “virtual image”.

The image processing unit 32 sets a mask region in the generated image (the first top view image and the second top view image). The mask region means a region set to hide a body of the vehicle 1 reflected in the image captured by the camera 111. The mask region is set as a region having a shape surrounding the vehicle 1. The image processing unit 32 displays a vehicle image showing the vehicle 1 by superimposing the vehicle image on a portion of the mask region corresponding to a space where the vehicle 1 is located. The vehicle image includes the first top view image, which is the “image in which the vehicle 1 is viewed from the sky behind the center of the vehicle with the traveling direction of the vehicle 1 included in an angle of view” and the second top view image, which is the “image in which the vehicle 1 is viewed from the sky in the vertical direction of the vehicle 1”, that is, includes a vehicle image corresponding to the first top view image and a vehicle image corresponding to the second top view image.

The image generated by the image processing unit 32 may be only an image to be displayed on the display unit such as the touch panel 22, or may include the image to be displayed and other images. That is, depending on the peripheral situation of the moving vehicle 1, the image processing unit 32 may generate only the image to be displayed on the touch panel 22 (for example, the first virtual image), or may generate an image including other images (the first captured image, the second top view image, and the second captured image).

The control unit 33 causes the vehicle 1 to autonomously move to the parking position 211 based on the acquired peripheral situation of the vehicle 1. Specifically, the control unit 33 performs a drive control, a braking control, and a steering control of the vehicle 1 via the driving

ECU 51, the braking ECU 61, and the EPS ECU 45 to perform an autonomous driving control with the parking position 211 designated by the user as the target parking position.

The display control unit 34 causes the display unit such as the touch panel 22 to display the image generated by the image processing unit 32. Specifically, the display control unit 34 displays the above first captured image and second top view image generated by the image processing unit 32 on the touch panel 22.

For example, when a distance from the current position of the vehicle 1 to the designated parking position 211 is equal to or greater than a predetermined value, the display control unit 34 causes the touch panel 22 to display the first top view image. The image to be displayed on the touch panel 22 during the movement of the vehicle 1 may be set by the user, for example. However, in the present embodiment, as described above, depending on the traveling situation, the situation of the vehicle 1 in the traveling direction may be desired to be known. For example, when the distance to the parking position is not short, in other words, when the distance is equal to or greater than the predetermined value, the situation of the vehicle 1 in the traveling direction may be desired to be known rather than the peripheral situation of the vehicle 1. Therefore, the display control unit 34 causes the touch panel 22 to display the first top view image generated by the image processing unit 32. That is, in order to show the situation in the traveling direction, the display control unit 34 causes an image viewed from the sky behind the vehicle 1 to be displayed.

In the first virtual image and the first captured image in the first top view image, the display control unit 34 preferably causes the touch panel 22 to display the first virtual image. This is because the captured image may display more information than that of the virtual image, which may cause information overload for the user. The setting of the first virtual image or the first captured image to be displayed may be appropriately performed by the manufacturer, the user, or the like of the vehicle 1. In the present embodiment, the first virtual image is essentially displayed except that a predetermined condition is satisfied.

On the other hand, when the distance from the current position of the vehicle 1 to the parking position 211 is short, in other words, when the distance is less than the predetermined value, the display control unit 34 causes the touch panel 22 to display the second top view image. That is, in order to show the peripheral situation of the vehicle 1, the display control unit 34 displays the image in which the vehicle 1 is viewed from above. This is because, since the parking position (that is, the target position) is approaching, the image to be displayed on the touch panel 22 is preferably an image showing the peripheral situation of the vehicle 1 rather than the image showing the situation of the vehicle 1 in the traveling direction.

In this way, the display control unit 34 switches the display between the first top view image and the second top view image depending on the distance between the current position of the vehicle 1 and the parking position 211 (depending on whether the distance is equal to or greater than the predetermined value or less than the predetermined value). Since information about the inside of the private land 210, such as the driveway 201, is not included in the map information database 24, the determination of whether the distance to the parking position 211 is less than the predetermined value is made by referring to the route data 35a. That is, when the route data 35a is recorded in the storage unit 35, the display control unit 34 refers to the route data 35a and switches the display between the first top view image and the second top view image depending on the distance to the parking position 211.

On the contrary, when the route data 35a is not recorded in the storage unit 35 (for example, when the route is first traveled for the vehicle 1, no route data is stored), the distance to the parking position 211 cannot be known even by referring to the route data 35a, and thus the display control unit 34 switches the display between the first top view image and the second top view image depending on the vehicle speed of the vehicle 1. Specifically, when the vehicle speed is equal to or greater than a predetermined speed, the display control unit 34 causes the touch panel 22 to display the first top view image, and when the vehicle speed is less than the predetermined speed, the display control unit 34 causes the touch panel 22 to display the second top view image. That is, the display control unit 34 determines whether the distance to the parking position 211 is less than the above predetermined value based on the detection value of the vehicle speed sensor 122, and switches the display between the first top view image and the second top view image. The vehicle speed may change depending on, for example, a sensing situation of the external sensor 11, and for example, when the parking position 211 is within a predetermined distance during the sensing, the vehicle speed is controlled to be less than a predetermined vehicle speed by the functions of the control unit 33 to perform the drive control and the braking control.

When the distance to the parking position 211 is less than the predetermined value and the parking position 211 is not included in an imaging range of the camera 111, the display control unit 34 causes the touch panel 22 to display the second virtual image, and when the distance to the parking position 211 is less than the predetermined value and the parking position 211 is included in the imaging range of the camera 111, the display control unit 34 causes the touch panel 22 to display the second captured image. Specifically, when the distance from the current position of the vehicle 1 to the parking position 211 becomes less than the predetermined value, the display control unit 34 switches the display of the touch panel 22 from the first top view image (the first virtual image in the present embodiment) to the second top view image. In this case, the second virtual image is first displayed as the second top view image. When the vehicle 1 further approaches the parking position 211 while the second virtual image is being displayed, and the parking position 211 is included in the imaging range of the camera 111, the display control unit 34 switches the display from the second virtual image to the second captured image.

When the distance to the parking position 211 is less than the predetermined value and the parking position 211 is included in the imaging range of the camera 111, the display control unit 34 causes the touch panel 22 to display a superimposed image in which the second captured image is superimposed on the second virtual image. The superimposed image is generated by the function of the image processing unit 32 described above. That is, the display control unit 34 causes the touch panel 22 to display the superimposed image generated by the image processing unit 32. In the present embodiment, the superimposed image is configured such that in the second virtual image and the second captured image, the second virtual image is displayed on the touch panel 22 first, and then the second captured image is superimposed on the displayed second virtual image to be displayed, but the relationship may be reversed. That is, the second virtual image may be superimposed on the second captured image.

When the distance to the parking position 211 is less than the predetermined value, and when the vehicle 1 passes through a place where the obstacle 202 is present or a place where a road width is narrow during the movement, the display control unit 34 preferably displays the image displayed on the touch panel 22 as a captured image. This is because, when the vehicle passes through the place where the obstacle 202 or the like is present or the place where the road width is narrow, the user may want to know the sense of distance from the obstacle 202 or a road boundary. That is, when the vehicle 1 passes through the place where the obstacle 202 is present or the place where the road width is narrow, the display control unit 34 causes the touch panel 22 to display the first captured image or the second captured image generated by the function of the image processing unit 32. Here, the image to be displayed on the touch panel 22 may be a captured image, but similar to the example of the parking position 211, the image to be displayed may be changed depending on, for example, the distance from the obstacle 202 or the imaging range of the camera 111. That is, when the distance from the obstacle 202 is equal to or greater than a predetermined value or when the obstacle 202 is included in the imaging range, the first captured image may be displayed on the touch panel 22, and when the distance is less than the predetermined value or when the obstacle 202 is not included in the imaging range, the second captured image may be displayed on the touch panel 22.

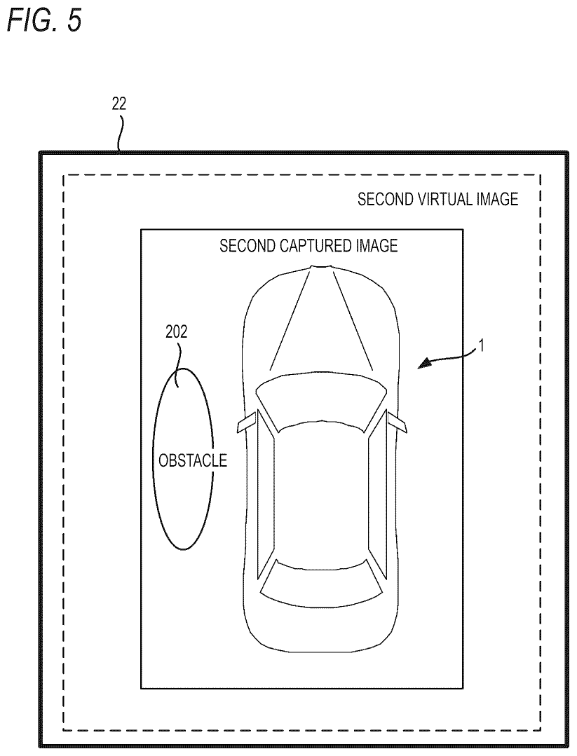

When the vehicle 1 passes through the place where the obstacle 202 is present or the place where the road width is narrow, the display control unit 34 causes the touch panel 22 to display a superimposed image in which the first captured image is superimposed on the first virtual image, or the superimposed image in which the second captured image is superimposed on the second virtual image. The superimposed image is generated by the function of the image processing unit 32 described above. That is, the display control unit 34 causes the touch panel 22 to display the superimposed image generated by the image processing unit 32. FIG. 5 is a diagram showing a display example of the touch panel 22 on which the superimposed image is displayed, and an image in which the second captured image shown in a solid line frame is superimposed on the second virtual image shown in a dashed line frame is displayed as the vehicle 1 passes through the place where the obstacle 202 is present. Accordingly, a user who sees the display on the touch panel 22 knows an image of the vicinity of the obstacle 202 including the vehicle 1 from the captured image, and further knows the peripheral situation from the virtual image. The superimposed image generated by the image processing unit 32 may be obtained by superimposing the first captured image (or the second captured image) on the first virtual image (or the second virtual image), and may be obtained by superimposing the first virtual image (or the second virtual image) on the first captured image (or the second captured image).

When the first top view image or the second top view image is being displayed on the touch panel 22, the display control unit 34 updates the image being displayed at each predetermined cycle based on the external information. That is, since the vehicle 1 is moving, the display control unit 34 dynamically updates the image to be displayed depending on the movement of the vehicle 1. When the display control unit 34 causes the touch panel 22 to display the top view image or switches the display of the top view image, the display control unit 34 may, for example, notify the user of the top view image to be displayed together by the speaker 23. This notification allows the user to easily know which top view image is currently being displayed.

### Processing Executed by Control Device

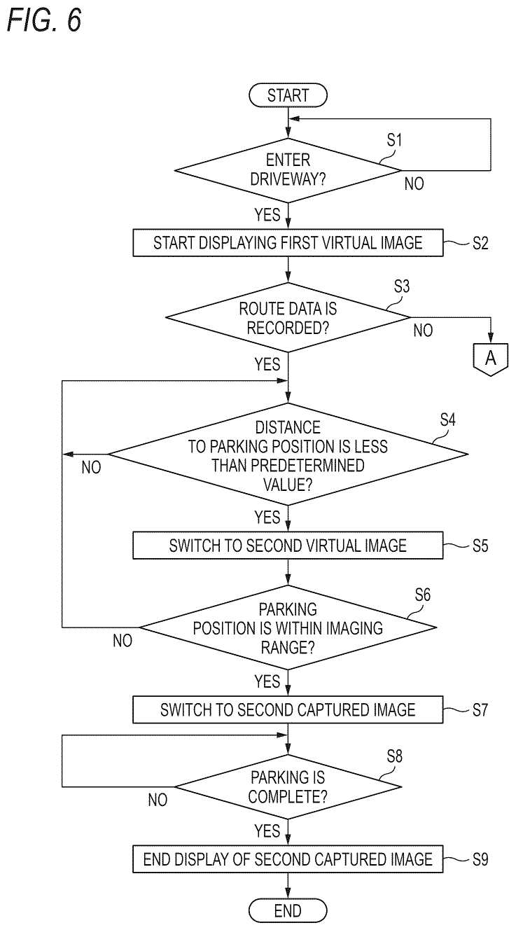

Next, an example of image display processing executed by the control device 30 will be described using a flowchart. FIG. 6 is a flowchart showing an example of the processing, and the processing is executed, for example, when the parking position, which is the target position, is designated and the operation switch for performing the autonomous driving is turned on. As described above, in the present embodiment, as described with reference to FIG. 2, the vehicle 1 enters the private land 210 from the general road 200 and moves to the parking position 211 through the driveway 201. The external sensor 11 constantly acquires external information while the vehicle 1 is moving toward the parking position, and the control device 30 generates the top view image based on the acquired external information at each predetermined cycle. As described above, the generated top view image includes the first virtual image, the first captured image, the second virtual image, and the second captured image.

The control device 30 first determines whether the vehicle 1 enters the driveway 201 (step S1), and if it is determined that the vehicle 1 does not enter the driveway 201 (No in step S1), the control device 30 waits until the vehicle 1 enters the driveway 201. On the contrary, if it is determined that the vehicle 1 enters the driveway 201 (Yes in step S1), the control device 30 proceeds the processing to step S2. Regarding the determination of whether the vehicle 1 enters the driveway 201, for example, when the information on the driveway 201 is recorded in the route data 35a, it is possible to determine whether the vehicle 1 enters the driveway 201 by referring to the route data 35a. On the other hand, for example, if the vehicle 1 enters the driveway 201 for the first time, the information on the driveway 201 is not recorded in the route data 35a, and thus, in this case, the driveway 201 is detected by the external sensor 11 such as the camera 111, and whether the vehicle enters the driveway 201 is determined based on the detected information.

In step S2, the control device 30 starts displaying the first virtual image (step S2). That is, the control device 30 uses the function of the display control unit 34 to cause the display unit such as the touch panel 22 to display the first virtual image generated by the image processing unit 32. Here, the first virtual image among the generated images is displayed because the situation of the vehicle 1 in the traveling direction is displayed and the captured image may cause information overload for the user.

Next, the control device 30 determines whether the route data 35a is recorded in the storage unit 35 (step S3). This is because the means for determining whether the vehicle 1 approaches the parking position 211 may change depending on the recording of the route data 35a. In step S3, if it is determined that the route data 35a is recorded in the storage unit 35 (Yes in step S3), the control device 30 proceeds the processing to step S4. The processing regarding the case where it is determined in step S3 that the route data 35a is not recorded in the storage unit 35 will be described later.

In step S4, the control device 30 determines whether the distance to the parking position 211 is less than the predetermined value. That is, the control device 30 refers to the route data 35a to recognize the current position of the vehicle 1, and determines whether the distance between the current position of the vehicle 1 and the parking position 211 is less than the predetermined value. If it is determined that the distance to the parking position 211 is equal to or greater than a threshold (No in step S4), the control device 30 waits until the distance becomes less than the threshold.

On the contrary, if it is determined that the distance to the parking position 211 is less than the threshold (Yes in step S4), the control device 30 switches the image to be displayed to the second virtual image (step S5). That is, the control device 30 switches the image to be displayed on the touch panel 22 from the first virtual image to the second virtual image by the function of the display control unit 34. That is, since the parking position 211 is close, the control device 30 switches the image to be displayed from the image showing the situation in the traveling direction to the image showing the peripheral image of the vehicle 1.

Next, the control device 30 determines whether the parking position 211 is within the imaging range (step S6). That is, the control device 30 determines whether the parking position 211 is included in the imaging range of the camera 111. If it is determined that the parking position 211 is not included in the imaging range (No in step S6), the control device 30 returns the processing to step S4.

On the other hand, if it is determined that the parking position 211 is included in the imaging range (Yes in step S6), the control device 30 switches the image to be displayed to the second captured image (step S7). That is, the control device 30 switches the image to be displayed on the touch panel 22 from the second virtual image to the second captured image by the function of the display control unit 34. That is, the control device 30 switches the display image from the second virtual image to the second captured image in order to display a more detailed peripheral image of the vehicle 1 on the touch panel 22.

Next, the control device 30 determines whether parking at the parking position 211 is complete (step S8). That is, the control device 30 determines whether the movement of the vehicle 1 to the target position designated by the user is complete. For example, the control device 30 identifies the position and the attitude of the vehicle 1 based on the detection of the camera 111 or the like by the function of the acquisition unit 31, and determines that the parking of the vehicle 1 at the parking position 211 is complete when the vehicle 1 is accommodated in a parking frame of the designated parking position 211 and the attitude of the vehicle 1 is parallel to a line indicating the parking frame. Alternatively, if it is determined that the shift position Ps of the shift device is in parking (P), it is determined that the parking is complete. The shift position Ps is determined based on a signal input from the shift position sensor 53 to the control device 30, for example. In step S8, if it is determined that the parking at the parking position 211 is not complete (No in step S8), the control device 30 waits until the parking is complete.

On the contrary, if it is determined that the parking at the parking position 211 is complete (Yes in step S8), the control device 30 ends the display of the second captured image being displayed on the touch panel 22 (step S9). That is, since the movement of the vehicle 1 is complete, the control device 30 ends the display of the peripheral image or the like of the vehicle 1.

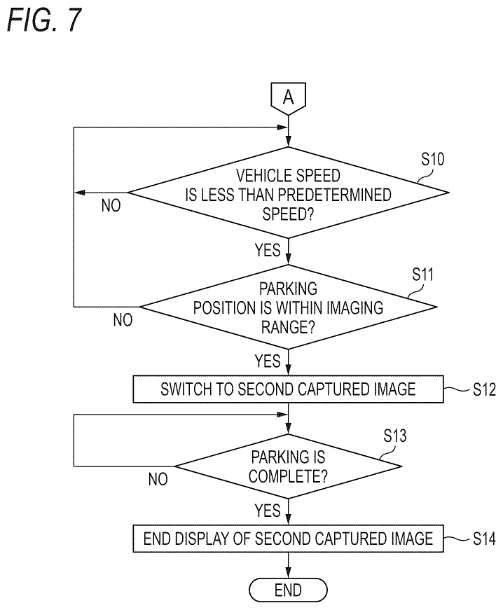

Next, the processing of the case where the negative determination is made in the above step S3 will be described with reference to FIG. 7. Among steps shown in FIG. 7, step S11 to step S14 are the same as the processing in the above step S6 to step S9. Therefore, detailed descriptions will be omitted and the descriptions will be simplified.

In step S3, if it is determined that the route data 35a is not recorded in the storage unit 35 (No in step S3), the control device 30 proceeds the processing to step S10. In step S10, the control device 30 determines whether the vehicle speed of the vehicle 1 is less than a predetermined speed. That is, since the route data 35a is not recorded in the storage unit 35, the control device 30 determines whether the vehicle 1 is approaching the parking position 211 based on the vehicle speed. If it is determined that the vehicle speed is equal to or greater than the predetermined speed (No in step S10), the control device 30 waits until the vehicle speed becomes less than the predetermined speed.

On the other hand, if it is determined that the vehicle speed is less than the predetermined speed (Yes in step S10), the control device 30 determines whether the parking position 211 is within the imaging range of the camera 111 (step S11). If it is determined that the parking position 211 is not included in the imaging range (No in step S11), the control device 30 returns the processing to step S10.

On the other hand, if it is determined that the parking position 211 is included in the imaging range (Yes in step S11), the image to be displayed on the touch panel 22 is switched from the first virtual image to the second captured image (step S12).

Next, the control device 30 determines whether the parking at the parking position 211 is complete (step S13). If it is determined that the parking at the parking position 211 is not complete (No in step S13), the control device 30 waits until the parking is complete.

On the contrary, if it is determined that the parking at the parking position 211 is complete (Yes in step S13), the control device 30 ends the display of the second captured image being displayed on the touch panel 22 (step S14).

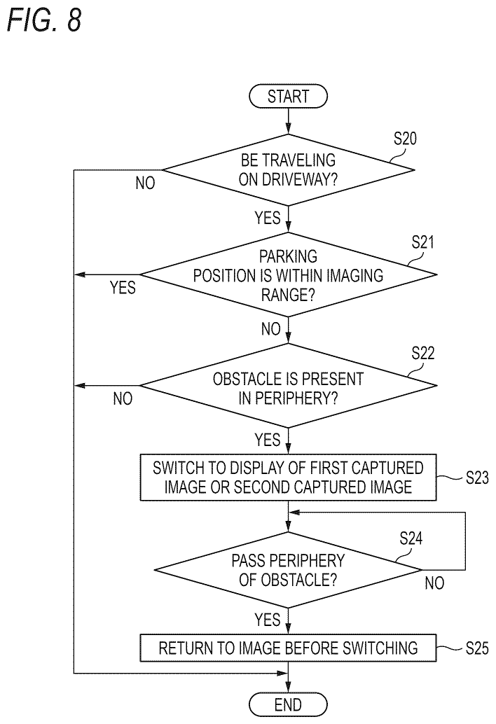

Next, an example of the image display processing of displaying the captured image when the presence of the obstacle 202 is recognized while the vehicle 1 is being moved to the parking position 211 will be described. FIG. 8 is a flowchart showing an example of the processing. The processing shown in this flowchart is executed in parallel with the processing illustrated in FIG. 6 and FIG. 7 above, for example, and is executed at each predetermined cycle.

First, the control device 30 determines whether the vehicle 1 is traveling on the driveway 201 (step S20). For example, when the information on the driveway 201 is recorded in the route data 35a, the control device 30 determines whether the vehicle 1 is traveling on the driveway 201 by referring to the route data 35a. When the information on the driveway 201 is not recorded in the route data 35a, the control device 30 determines whether the vehicle 1 is traveling on the driveway 201 based on the detection value obtained by the external sensor 11. In step S20, if it is determined that the vehicle 1 is not traveling on the driveway 201 (No in step S20), the control device 30 temporarily ends the processing of the flowchart shown in FIG. 8.

On the contrary, if it is determined that the vehicle 1 is traveling on the driveway 201 (Yes in step S20), the control device 30 determines whether the parking position 211 is within the imaging range of the camera 111 (step S21). If it is determined that the parking position 211 is included in the imaging range of the camera 111 (Yes in step S21), as described in step S7 of FIG. 6 and step S12 of FIG. 7, the second captured image is already displayed on the touch panel 22, and thus the control device 30 temporarily ends the processing of the flowchart shown in FIG. 8.

On the contrary, if it is determined that the parking position 211 is not included in the imaging range of the camera 111 (No in step S21), the control device 30 determines whether the obstacle 202 is present in the periphery of the vehicle 1 (step S22). For example, the control device 30 determines whether the obstacle 202 is present by referring to the route data 35a or based on the detection value of the external sensor 11. If it is determined that the obstacle 202 is not present in the periphery of the vehicle 1 (No in step S22), the control device 30 temporarily ends the processing of the flowchart shown in FIG. 8. On the other hand, if it is determined that the obstacle 202 is present in the periphery of the vehicle 1 (Yes in step S22), the control device 30 proceeds the processing to step S23.

In step S23, the control device 30 switches the display of the touch panel 22 to the first captured image or the second captured image. In a case of traveling in a situation where the presence of the obstacle 202 is not detected, it can be assumed that the first virtual image is displayed on the touch panel 22. Therefore, if it is determined that the obstacle 202 is present in the periphery of the vehicle 1, the control device 30 switches the display of the touch panel 22 to the captured image by the function of the display control unit 34. The captured image displayed in this case may be either the first captured image or the second captured image. For example, when the obstacle 202 is not included in the imaging range of the camera 111, the control device 30 causes the first captured image to be displayed, and when the obstacle 202 is included in the imaging range, the control device 30 causes the second captured image to be displayed.

Next, the control device 30 determines whether the vehicle 1 passes the periphery of the obstacle 202 (step S24). The control device 30 determines whether the vehicle 1 passes the periphery of the obstacle 202, for example, by referring to the route data 35a or based on the detection value of the external sensor 11. In this step S24, if it is determined that the vehicle 1 does not pass the periphery of the obstacle 202 (No in step S24), the control device 30 waits until the vehicle 1 passes the periphery of the obstacle 202.

On the contrary, if it is determined that the vehicle 1 passes the periphery of the obstacle 202 (Yes in step S24), the control device 30 returns the display image to the image displayed before being switched to the captured image (first captured image or second captured image) in step S23 (step S25). That is, when the first virtual image is displayed on the touch panel 22 before being switched to the captured image in step S23, the display is switched to the first virtual image. Instead of the switching (that is, the return of the display), the control device 30 may determine whether the distance to the parking position 211 when the vehicle 1 passes the obstacle 202 is within the predetermined value, whether the parking position 211 is included in the imaging range, or whether the vehicle speed is less than the predetermined speed, and may switch the image to be displayed on the touch panel 22 based on the determination result.

As described above, in the present embodiment, the top view image to be displayed on the touch panel 22 is switched depending on the distance to the parking position 211. That is, when the distance to the parking position 211 is equal to or greater than the predetermined value, the control device 30 displays the first top view image that allows the user to know the situation of the vehicle 1 in the traveling direction, and when the distance to the parking position 211 is less than the predetermined value, the control device 30 displays the second top view image that allows the user to know the peripheral situation of the vehicle 1. Since the display image requested by the user may differ during the route, it is possible to display depending on the traveling situation of the vehicle by switching the display depending on the distance to the target position such as the parking position. By executing such processing, the control device 30 can improve safety of traffic and contribute to development of a sustainable transportation system.

In the present embodiment, in the case of switching the display between the first top view image and the second top view image, when the route data 35a is recorded, the control device 30 switches the display between the first top view image and the second top view image based on the route data 35a. As described above, the driveway 201 and the like are roads in the private land, and therefore no route is present in the map information database 24. In such a case, by recording the route data 35a different from the map information database 24, the position of the vehicle 1 can also be recognized based on the route data 35a, and the display image can be switched.

When the route data 35a is not recorded, the control device 30 switches the display between the first top view image and the second top view image depending on the vehicle speed. For example, the control device 30 displays the first top view image when the vehicle speed is equal to or greater than the predetermined speed, and displays the second top view image when the vehicle speed is less than the predetermined speed. In this way, whether the vehicle is approaching the target position such as the parking position can be determined depending on a change in the vehicle speed, and the top view image to be displayed can be switched.

In the present embodiment, when the distance to the parking position 211 is less than the predetermined value and the parking position 211 is not included in the imaging range of the camera 111, the control device 30 displays the second virtual image, and when the distance to the parking position 211 is less than the predetermined value and the parking position 211 is included in the imaging range, the control device 30 displays the second captured image. In this way, by switching the image to be displayed in the second top view image depending on whether the parking position 211 is included in the imaging range, it is possible to display the captured image that is a more detailed image than the virtual image when the distance to the parking position becomes shorter.

The control device 30 also causes the touch panel 22 to display the first captured image or the second captured image when the vehicle 1 passes through the place where the obstacle or the like is present. When the vehicle passes through the place where the obstacle or the like is present, the user may want to see a detailed image. Therefore, by displaying such a captured image, it is possible to satisfy a request of the user.

In the present embodiment, when the parking position 211 is included in the imaging range or when the vehicle 1 passes the place where the obstacle 202 is present, the control device 30 superimposes the captured image on the virtual image. As described above, when approaching the target position such as the parking position 211 or passing the place where the obstacle 202 is present, it is preferable to display the captured image that can display the detailed image, but the captured image alone may not provide enough information about the peripheral situation. Therefore, by superimposing the captured image on the virtual image displayed before the captured image is displayed, the peripheral image closer to the vehicle 1 is displayed by the captured image, and the periphery of the peripheral image is displayed by the virtual image. Therefore, it is possible to reduce a possibility that the displayed image does not provide enough information about the peripheral situation of the vehicle 1.

In the present embodiment, by displaying the top view image showing the situation of the vehicle 1 in the traveling direction during the traveling or the top view image showing the peripheral situation of the vehicle 1 on the touch panel 22, it is possible to execute an override that allows a user operation to intervene when an abnormality occurs in a behavior of the vehicle 1 during the autonomous driving, for example. That is, by displaying not only the peripheral image of the vehicle 1 but also the image of the situation in the traveling direction, the user can execute the override with ample time.

### Another Embodiment

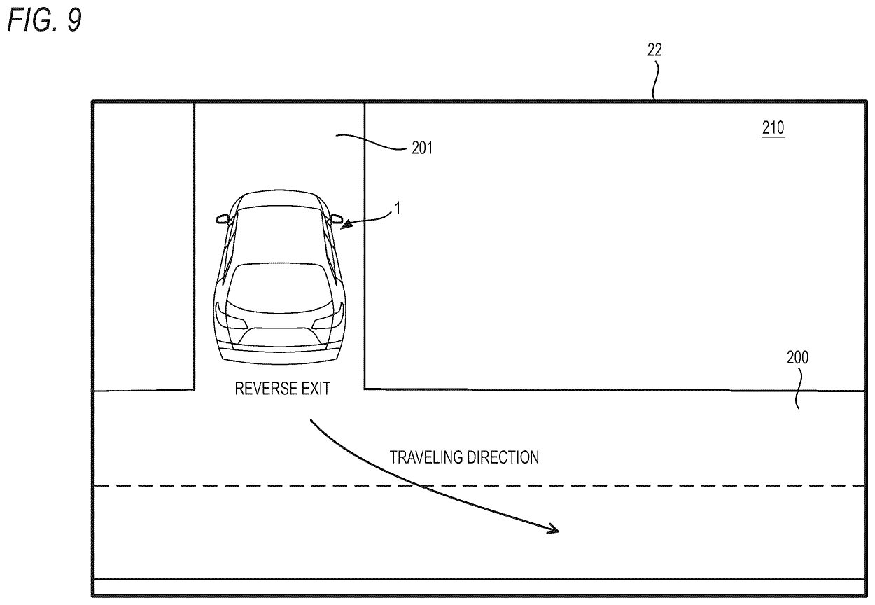

Next, another embodiment will be described. In the above embodiment, the direction in which the vehicle 1 moves forward is described as the traveling direction, but the vehicle 1 may also move in a reverse direction as the traveling direction. For example, using the above driveway 201 as an example, a case can be assumed in which the vehicle moves in reverse from the parking position 211, passes through the driveway 201, and exits to the general road 200. That is, there is a case where the vehicle moves out to the general road 200 by exiting from the parking position 211 in reverse. FIG. 9 shows an example of moving out to the general road 200 from the driveway 201 in the case of reverse exit. In FIG. 9, in order to know a situation in an arrow direction in which the vehicle 1 is to perform reverse exit, the top view image in which the vehicle 1 is viewed from the sky behind the center of the vehicle (that is, in front of the vehicle) is displayed on the touch panel 22 with the traveling direction of the vehicle 1 (arrow direction) included in the angle of view. Accordingly, the user can know the situation in the direction in which the vehicle 1 is to move in reverse, and thus, compared to the case where only the peripheral image of the vehicle 1 is displayed on the touch panel 22, a possibility of the reverse exit being easier can be increased.

In the above embodiment, the example of the case where the image display processing is executed during the autonomous driving has been described, but the processing may be executed not only during the autonomous driving but also during manual driving. By executing the processing during the manual driving, the user can travel while viewing the top view image displayed on the touch panel 22, and thus effective driving assistance can be provided to the user.

The processing of the flowchart illustrated in FIG. 8 above is applied to an example in which the obstacle 202 or the like is present, and may also be applied, for example, when the vehicle passes through a place where a road is narrow. That is, when the vehicle 1 passes through the place having the road narrow to the vehicle 1, the image displayed on the touch panel 22 may be switched to the first captured image or the second captured image. That is, the processing may be applied when the vehicle passes through the target position such as the parking position 211, or a place that requires attention or focus during the traveling.

### Others

Although the embodiments of the present invention have been described above with reference to the drawings, it goes without saying that the present invention is not limited to the embodiments described above. It is apparent that those skilled in the art may conceive of various modifications and changes within the scope described in the claims, and it is understood that such modifications and changes naturally fall within the technical scope of the present invention.

For example, the image display processing described above is executed when an operation to turn on the autonomous driving is performed, but may be executed when the vehicle 1 enters the driveway 201 and the operation to turn on the automatic parking is performed.

For example, the parking position 211 described above is set by the designation of the user, but the parking position 211 may be directly designated by the operation of the touch panel 22 or the like, and for example, by designating a home, the parking position 211 that is pre-linked to the home may be designated.

The control method described in the above embodiment may be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present specification, at least the following matters are described. Although corresponding constituent elements in the embodiment described above are shown in parentheses, the present invention is not limited thereto.

(1) A control device (control device 30) that causes a vehicle (vehicle 1) to move to a predetermined target position (park position 211), the control device including:
an acquisition unit (acquisition unit 31) configured to acquire external information indicating a situation of a periphery of the vehicle from an external sensor (external sensor 11) including an imaging device (camera 111) for imaging the periphery of the vehicle; an image processing unit (image processing unit 32) configured to generate, based on the acquired external information, a first top view image in which the vehicle is viewed from sky and from a rear side with respect to a center of the vehicle in a traveling direction of the vehicle with a front side in the traveling direction included in an angle of view, and a second top view image in which the vehicle is viewed from the sky in a vertical direction of the vehicle;
a control unit (control unit 33) configured to control movement of the vehicle to the target position; and
a display control unit (display control unit 34) configured to cause a predetermined display unit (touch panel 22) to display images generated by the image processing unit, in which
the display control unit is configured to
   cause the display unit to display the first top view image in response to a distance to the target position being equal to or greater than a predetermined value, and
   cause the display unit to display the second top view image in response to the distance to the target position being less than the predetermined value.

According to (1), when the distance to the target position is equal to or greater than the predetermined value, the first top view image that allows the user to know a situation of the vehicle in the traveling direction is displayed, and when the distance to the target position is less than the predetermined value, the second top view image that allows the user to know the peripheral situation of the vehicle is displayed. Since the display image requested by the user may differ during the route, it is possible to display depending on the traveling situation of the vehicle by switching the display depending on the distance to the target position such as a parking position. By executing such processing, the control device can improve safety of traffic and contribute to development of a sustainable transportation system.

(2) The control device according to (1), further including:
a storage unit (storage unit 35) configured to record route data (route data 35a) which is a route history of a route used when the vehicle moves to the target position, in which
the display control unit is configured to
   switch display between the first top view image and the second top view image depending on the distance to the target position when the route data is recorded in the storage unit, and
   switch the display between the first top view image and the second top view image depending on a vehicle speed of the vehicle when the route data is not recorded in the storage unit.

According to (2), it is possible to switch the display between the first top view image and the second top view image based on the route data.

(3) The control device according to (2), in which
the display control unit is configured to
   cause the display unit to display the first top view image when the route data is not recorded in the storage unit and the vehicle speed is equal to or greater than a predetermined speed, and
   cause the display unit to display the second top view image when the route data is not recorded in the storage unit and the vehicle speed is less than the predetermined speed.

According to (3), when the route data is not recorded in the storage unit, the control device can switch the display between the first top view image and the second top view image depending on the vehicle speed.

(4) The control device according to (1), in which
the first top view image is displayed by at least one of a first captured image based on imaging data of the imaging device and a first virtual image which is a virtual three- dimensional image generated based on the imaging data,
the second top view image is displayed by at least one of a second captured image based on the imaging data and a second virtual image which is a virtual image generated based on the imaging data, and
the display control unit is configured to
   cause the display unit to display the second virtual image in response to the distance to the target position being less than the predetermined value and the target position being not included in an imaging range of the imaging device, cause the display unit to display the second captured image in response to the distance to the target position being less than the predetermined value and the target position being included in the imaging range, and
   cause the display unit to display the first captured image or the second captured image in response to an obstacle being present in the periphery of the vehicle.

According to (4), by switching the image to be displayed in the second top view image depending on whether the target position is included in the imaging range between the second virtual image and the second captured image, it is possible to display the captured image that is more detailed than the virtual image when the distance to the parking position becomes shorter. When the vehicle passes through the place where the obstacle or the like is present, it is possible to display the captured image that is more detailed than the virtual image.

(5) The control device according to (4), in which
the image processing unit superimposes the second captured image on the second virtual image when the distance to the target position is less than the predetermined value and the target position is included in the imaging range, and
the display control unit causes the display unit to display the superimposed image.

According to (5), when the target position is included in the imaging range, by superimposing the captured image on the virtual image, information that may be insufficient in the captured image alone, for example, can be supplemented by the virtual image.

(6) The control device according to (4), in which
the image processing unit superimposes the first captured image on the first virtual image or superimposes the second captured image on the second virtual image when the obstacle is present in the periphery of the vehicle, and
the display control unit causes the display unit to display the superimposed image.

According to (6), when the obstacle is present, by superimposing the captured image on the virtual image, information that may be insufficient in the captured image alone, for example, may be supplemented by the virtual image.

(7) A control method, including:
acquiring, by a computer that causes a vehicle (vehicle 1) to move to a predetermined target position (park position 211), external information indicating a situation of a periphery of the vehicle from an external sensor (external sensor 11) including an imaging device (camera 111) for imaging the periphery of the vehicle,
generating, by the computer, based on the acquired external information, a first top view image in which the vehicle is viewed from sky and from a rear side with respect to a center of the vehicle in a traveling direction of the vehicle with a front side in the traveling direction included in an angle of view, and a second top view image in which the vehicle is viewed from the sky in a vertical direction of the vehicle,
controlling, by the computer, movement of the vehicle to the target position,
causing, by the computer, a predetermined display unit (touch panel 22) to display the generated images,
causing, by the computer, the display unit to display the first top view image in response to a distance to the target position being equal to or greater than a predetermined value, and
causing, by the computer, the display unit to display the second top view image in response to the distance to the target position being less than the predetermined value.

According to (7), when the distance to the target position is equal to or greater than the predetermined value, the first top view image that allows the user to know the situation of the vehicle in the traveling direction is displayed, and when the distance to the target position is less than the predetermined value, the second top view image that allows the user to know the peripheral situation of the vehicle is displayed. Since the display image requested by the user may differ during the route, it is possible to display depending on the traveling situation of the vehicle by switching the display depending on the distance to the target position such as a parking position.

(8) A non-transitory computer-readable storage medium storing a control program causing a computer that causes a vehicle (vehicle 1) to move to a predetermined target position (park position 211) to execute a process, the process including:
acquiring external information indicating a situation of a periphery of the vehicle from an external sensor (external sensor 11) including an imaging device (camera 111) for imaging the periphery of the vehicle,
generating, based on the acquired external information, a first top view image in which the vehicle is viewed from sky and from a rear side with respect to a center of the vehicle in a traveling direction of the vehicle with a front side in the traveling direction included in an angle of view, and a second top view image in which the vehicle is viewed from the sky in a vertical direction of the vehicle,
controlling movement of the vehicle to the target position,
causing a predetermined display unit (touch panel 22) to display the generated images,
causing the display unit to display the first top view image in response to a distance to the target position being equal to or greater than a predetermined value, and
causing the display unit to display the second top view image in response to the distance to the target position being less than the predetermined value.

According to (8), when the distance to the target position is equal to or greater than the predetermined value, the first top view image that allows the user to know the situation of the vehicle in the traveling direction is displayed, and when the distance to the target position is less than the predetermined value, the second top view image that allows the user to know the peripheral situation of the vehicle is displayed. Since the display image requested by the user may differ during the route, it is possible to display depending on the traveling situation of the vehicle by switching the display depending on the distance to the target position such as a parking position.

(9) A control device (control device 30) that causes a vehicle (vehicle 1) to move to a predetermined target position (park position 211), the control device including:
an acquisition unit (acquisition unit 31) configured to acquire external information indicating a peripheral situation of the vehicle from an external sensor (external sensor 11) including an imaging device (camera 111) for imaging the periphery of the vehicle;
an image processing unit (image processing unit 32) configured to generate, based on the acquired external information, a top view image in which the vehicle is viewed from the sky and from a rear side with respect to a center of the vehicle in a traveling direction of the vehicle with a front side in the traveling direction included in an angle of view;
a control unit (control unit 33) configured to control movement of the vehicle to the target position; and
a display control unit (display control unit 34) configured to cause a predetermined display unit (touch panel 22) to display the top view image generated by the image processing unit, in which
the display control unit causes the display unit to display the top view image when the vehicle moves in reverse to a predetermined place.

According to (9), in order to know the situation in a direction in which the vehicle is to perform reverse exit, the top view image in which the vehicle is viewed from the sky behind the vehicle in the traveling direction (that is, in front of the vehicle) is displayed on the display unit. Accordingly, the user can know the situation in the direction in which the vehicle is to move in reverse, and thus, compared to a case where only a peripheral image of the vehicle is displayed on the display unit, a possibility of the reverse exit being easier may be increased.

What is claimed is:

1. A control device that causes a vehicle to move to a predetermined target position, the control device comprising:
an acquisition unit configured to acquire external information indicating a situation of a periphery of the vehicle from an external sensor including an imaging device for imaging the periphery of the vehicle;
an image processing unit configured to generate, based on the acquired external information, a first top view image in which the vehicle is viewed from sky and from a rear side with respect to a center of the vehicle in a traveling direction of the vehicle with a front side in the traveling direction included in an angle of view, and a second top view image in which the vehicle is viewed from the sky in a vertical direction of the vehicle;
a control unit configured to control movement of the vehicle to the target position; and
a display control unit configured to cause a predetermined display unit to display images generated by the image processing unit, wherein
the display control unit is configured to
cause the display unit to display the first top view image in response to a distance to the target position being equal to or greater than a predetermined value, and
cause the display unit to display the second top view image in response to the distance to the target position being less than the predetermined value.

2. The control device according to claim 1, further comprising:
a storage unit configured to record route data which is a route history of a route used when the vehicle moves to the target position, wherein
the display control unit is configured to
switch display between the first top view image and the second top view image depending on the distance to the target position when the route data is recorded in the storage unit, and
switch the display between the first top view image and the second top view image depending on a vehicle speed of the vehicle when the route data is not recorded in the storage unit.

3. The control device according to claim 2, wherein
the display control unit is configured to
cause the display unit to display the first top view image when the route data is not recorded in the storage unit and the vehicle speed is equal to or greater than a predetermined speed, and
cause the display unit to display the second top view image when the route data is not recorded in the storage unit and the vehicle speed is less than the predetermined speed.

4. The control device according to claim 1, wherein
the first top view image is displayed by at least one of a first captured image based on imaging data of the imaging device and a first virtual image which is a virtual three- dimensional image generated based on the imaging data,
the second top view image is displayed by at least one of a second captured image based on the imaging data and a second virtual image which is a virtual image generated based on the imaging data, and
the display control unit is configured to
cause the display unit to display the second virtual image in response to the distance to the target position being less than the predetermined value and the target position being not included in an imaging range of the imaging device,
cause the display unit to display the second captured image in response to the distance to the target position being less than the predetermined value and the target position being included in the imaging range, and
cause the display unit to display the first captured image or the second captured image in response to an obstacle being present in the periphery of the vehicle.

5. The control device according to claim 4, wherein
the image processing unit superimposes the second captured image on the second virtual image when the distance to the target position is less than the predetermined value and the target position is included in the imaging range, and
the display control unit causes the display unit to display the superimposed image.

6. The control device according to claim 4, wherein
the image processing unit superimposes the first captured image on the first virtual image or superimposes the second captured image on the second virtual image when the obstacle is present in the periphery of the vehicle, and
the display control unit causes the display unit to display the superimposed image.

7. A control method, comprising:
acquiring, by a computer that causes a vehicle to move to a predetermined target position, external information indicating a situation of a periphery of the vehicle from an external sensor including an imaging device for imaging the periphery of the vehicle,
generating, by the computer, based on the acquired external information, a first top view image in which the vehicle is viewed from sky and from a rear side with respect to a center of the vehicle in a traveling direction of the vehicle with a front side in the traveling direction included in an angle of view, and a second top view image in which the vehicle is viewed from the sky in a vertical direction of the vehicle,
controlling, by the computer, movement of the vehicle to the target position,
causing, by the computer, a predetermined display unit to display the generated images,
causing, by the computer, the display unit to display the first top view image in response to a distance to the target position being equal to or greater than a predetermined value, and
causing, by the computer, the display unit to display the second top view image in response to the distance to the target position being less than the predetermined value.

8. A non-transitory computer-readable storage medium storing a control program causing a computer that causes a vehicle to move to a predetermined target position to execute a process, the process comprising:
acquiring external information indicating a situation of a periphery of the vehicle from an external sensor including an imaging device for imaging the periphery of the vehicle,
generating, based on the acquired external information, a first top view image in which the vehicle is viewed from sky and from a rear side with respect to a center of the vehicle in a traveling direction of the vehicle with a front side in the traveling direction included in an angle of view, and a second top view image in which the vehicle is viewed from the sky in a vertical direction of the vehicle,
controlling movement of the vehicle to the target position,
causing a predetermined display unit to display the generated images,
causing the display unit to display the first top view image in response to a distance to the target position being equal to or greater than a predetermined value, and
causing the display unit to display the second top view image in response to the distance to the target position being less than the predetermined value.

9. A control device that causes a vehicle to move to a predetermined target position, the control device comprising:
an acquisition unit configured to acquire external information indicating a peripheral situation of the vehicle from an external sensor including an imaging device for imaging the periphery of the vehicle;
an image processing unit configured to generate, based on the acquired external information, a top view image in which the vehicle is viewed from the sky and from a rear side with respect to a center of the vehicle in a traveling direction of the vehicle with a front side in the traveling direction included in an angle of view;
a control unit configured to control movement of the vehicle to the target position; and
a display control unit configured to cause a predetermined display unit to display the top view image generated by the image processing unit, wherein
the display control unit causes the display unit to display the top view image when the vehicle moves in reverse to a predetermined place.
